(19) United States
(12) Patent Application Publication
(10) Pub. No.: US 2003/0031989 A1
(43) Pub. Date: Feb. 13, 2003

(54) Accociational instructional method

(76) Inventor: Kathleen Agnes Byrne, Santa Cruz, CA (US)

Correspondence Address: Jeffrey A. Hall, 212 Clinton Street, Santa Cruz, CA, 95062, US

(21) Appl. No.: 09/855,407

(22) Filed: May 14, 2001

(51) Int. Cl. G09B 19/00

(52) U.S. Cl. 434/159

(57) ABSTRACT

An instructional method for teaching the sounds of the alphabet, the formation of the strokes of the letters of the alphabet, and the placement of the letters of the alphabet on primary lined paper, comprising, instructing the learning of a sound of a letter of the alphabet prior to any instruction on sound blending. Each letter of the alphabet is illustrated by incorporating an object which conforms to a shape of a writing stroke for each letter. The object is selected having the same beginning sound as the letter being illustrated. The exact and correct positioning for each stroke which comprises a letter of the alphabet on primary spaced and lined paper is then taught.

### BACKGROUND OF THE INVENTION 37 C.F.R. 1.77(a)(7)

1. Field of Invention

This invention relates to instructional methods for teaching the sounds of the letters of the alphabet, the formation of the strokes of the letters of the alphabet, and the correct placement of the strokes of the letters on primary lined paper. In particular, the present method uses an associational methodology combined with multisensory aids to instruct and facilitate the learning of letter sounds, letter formation, and letter placement on lined paper. 35

2. Description of the Related Art

Heretofore a wide variety of instructional methods and devices have been proposed and implemented for teaching the sounds and letters of the alphabet, and using various illustrations and techniques for such instruction. The present invention provides a unique associational methodology for teaching the sounds of the letters of the alphabet, the formation of the strokes of the letters, and the placement of the letters on primary lined paper, by using the theory of association, in conjunction with a multisensory approach.

The present method and associated instructional material provides a significant improvement over prior instructional methods and is easily and efficiently incorporated into both classroom or private instruction. It is designed to accommodate any age, ability, or English acquisition level. It is very effective with the average student as well as the “gifted,” “learning disabled,” “dyslexic,” “slow learner,” “limited learner,” or “English as a Second Language” learner.

Prior attempts to formulate instructional methods and materials to facilitate the learning of the sounds of the letters of the alphabet, the formation of strokes of the letters, and the placement of the letters on lined paper, have been limited by inefficiencies and inconsistent results. The present invention provides an efficient and unique method and associated materials for rapid learning of such subjects.

Accordingly, it is the primary object of this invention to provide a highly efficient and effective method for teaching the sounds of the letters of the alphabet, the formation of strokes of the letters of the alphabet, and the correct placement of the letters on primary lined paper. It is a further object to provide instructional cards, paper, and banners for the implementation of this methodology.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMARY OF THE INVENTION 37 C.F.R. 1.77(a)(8)

The present invention is an instructional method for teaching the sounds of the letters of the alphabet, the formation of strokes of the letters of the alphabet, and the correct placement of the letters on primary lined paper. In particular, the present method uses an associational methodology combined with multisensory aids to instruct and facilitate the learning of letter sounds, letter formation, and letter placement on lined paper.

Using the present method, each lower case letter of the alphabet is illustrated by incorporating objects that form the shape of each stroke, and have the same beginning sound that letter makes. An example is the letter b in which a bat takes the shape of the first stroke, and a ball takes the shape of the second stroke. Both the words bat and ball start with the /b/ sound, the sound the letter b makes. Through this visual imagery students learn to form the strokes of the letter, learn the sound the letter makes, and learn to write the letter, when the sound of the letter is heard. Since the most common sound of the letter x, /ks/, is not found at the beginning of any words, the letter x is the only letter in the present methodology that is represented by objects that have the letter x (pronounced /ks/) at the end of the word.

The short vowel sound, rather than the long vowel sound, is introduced for the vowels (a, e, i, o, and u) because 1) the sound of short vowels is easier to pronounce than the sound of long vowels, 2) words with short vowels are easier to read and spell than words with long vowels, and 3) words with short vowels are presented before words with long vowels in most reading programs. A short vowel word usually takes less letters to spell than a long vowel word, and for this reason it is easier to decode (read) and encode (spell) a short vowel word, than a long vowel word.

In the present method, the sound of the letter, the formation of the letter, and the name of the letter (at teacher discretion), are taught before any sound blending begins. This allows for reinforcement of the following skills: letter sound association, sound letter association, visual discrimination of letter shapes, auditory discrimination of letter sounds, development of motor skills involved in handwriting, beginning sound recognition in words, auditory discrimination of letter names, and letter name recall, if the letter name is taught.

A unique feature of this method is that in addition to teaching the sound of the letter, this program teaches the exact positioning of each stroke of each letter, on primary lined paper, specially designed for this purpose. On individual clue cards for each lowercase letter, each object that represents each stroke of each lowercase letter, is confined to the shape of that stroke, and confined within lines that are spaced the same as the lines on the specially designed primary lined paper. The lines on the lowercase clue cards, that build the letter sound association, are each a different color, and are each color referenced and spatially referenced with a spatial/line association clue card. The colored lines on the lowercase clue cards, and the spatial/line association clue card, both match the color of the lines on the specially designed primary spaced paper. The specially designed primary spaced paper has the spatial/line association clue, printed on the lines of the paper, and also has the upper and lowercase manuscript letters printed on the top of the paper for near point reference. Thus the transfer of letter strokes from the clue card, or the top of the paper, is made with a color reference and a spatial reference. The exact direction of each stroke of all lowercase and uppercase letters are also shown on a separate set of cards, which color codes each stroke, numbers the order of the strokes, displays the stroke within the letter itself, and also includes the color lines for a spatial reference for the placement of the strokes on the specially designed primary spaced paper. A set of cards with lowercase and uppercase manuscript letters, without any clues or directions of strokes, is also a part of the program, to test the letter sound, and/or the formation of the letters without any visual clues.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows a “first impression line card”, according to the invention.

FIG. 2 shows a “first impression letter card”, illustrating the letter “a”, according to the invention.

FIG. 3 shows a “first impression letter card”, illustrating the letter “b”, according to the invention.

FIG. 4 shows a “first impression letter card” illustrating the letter “p”, according to the invention.

FIG. 5 shows a “way to go card”, illustrating the letter “a”, according to the invention.

FIG. 6 shows a “way to go card”, illustrating the letter “b”, according to the invention.

FIG. 7 shows a “way to go card”, illustrating the letter “p”, according to the invention.

FIG. 8 shows a “do you know card”, illustrating the letter “b”, according to the invention.

FIG. 9 shows a “write on color” paper, illustrating the use of colored, lined paper of the present method, according to the invention.

FIG. 10 shows an “up for show” banner, according to the invention.

### DETAILED DESCRIPTION OF THE INVENTION 37 C.F.R. 1.77(a)(10)

Reference will now be made in detail to the present preferred embodiments of the invention as illustrated in the accompanying drawings.

In accordance with the present invention, there is provided an instructional method for teaching the sounds of the alphabet, the formation of the strokes of the letters of the alphabet, and the placement of the letters of the alphabet on primary lined paper, comprising, instructing the learning of a sound of a letter of the alphabet prior to any instruction on sound blending. Each letter of the alphabet is illustrated by incorporating an object which conforms to a shape of a writing stroke for each letter. The object is selected having the same beginning sound as the letter being illustrated. The exact and correct positioning for each stroke which comprises a letter of the alphabet on primary spaced and lined paper is then taught.

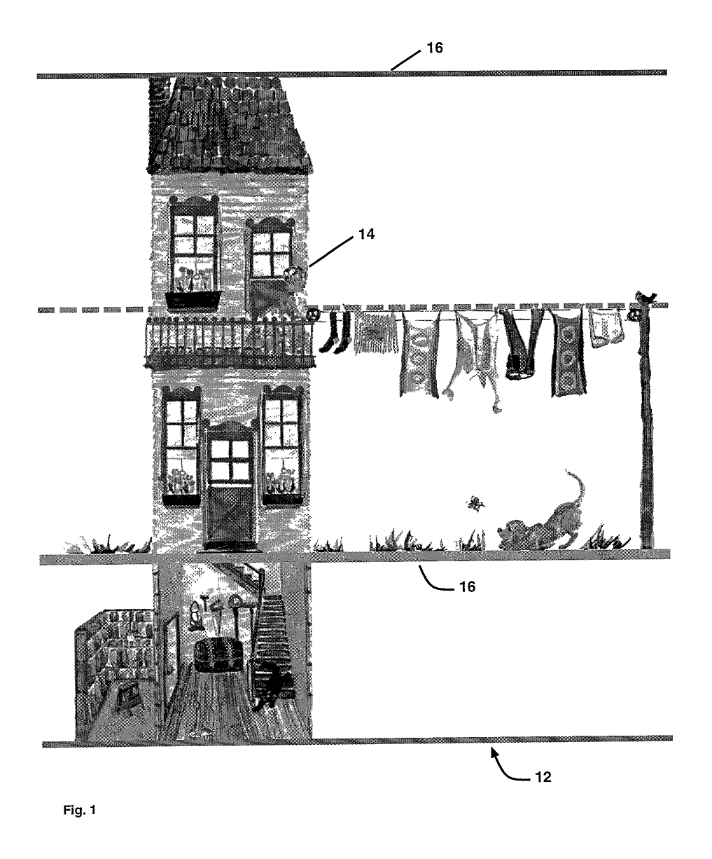

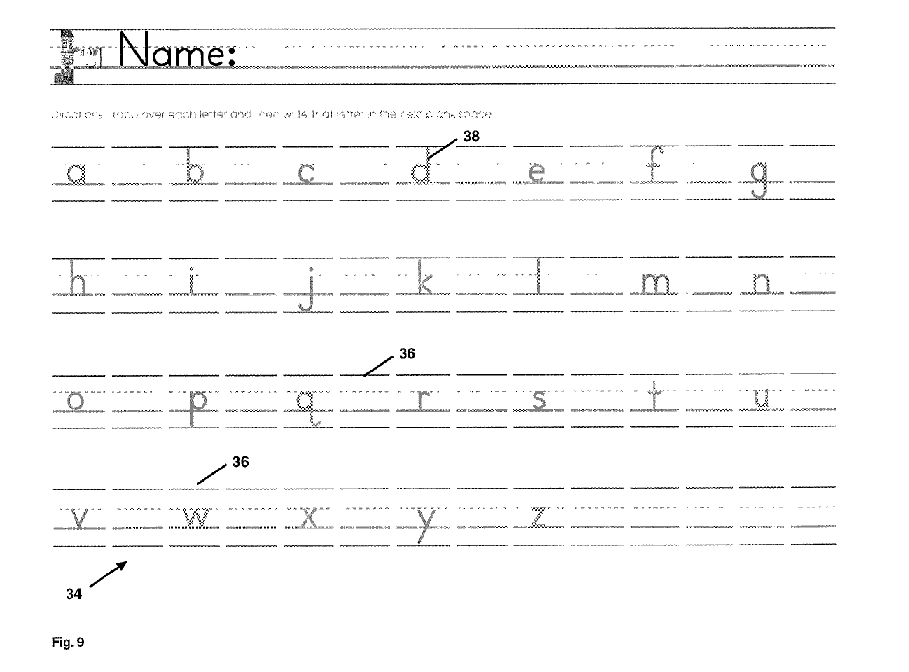

In FIG. 1, an example of a “first impression line card” 12, is shown. In the preferred method, a plurality of such cards with visual imagery 14, represents the spacing and lines on the “write on color paper” seen in FIG. 9. A plurality of spaced lines 16, which are preferably colored, and which may be solid or spaced are provided and are placed at spatially correct positions within the visual imagery, so as to give a spatial reference and color clue to help the student form and position the strokes of the letters on the write on color paper seen in FIG. 9, or traditional primary lined paper.

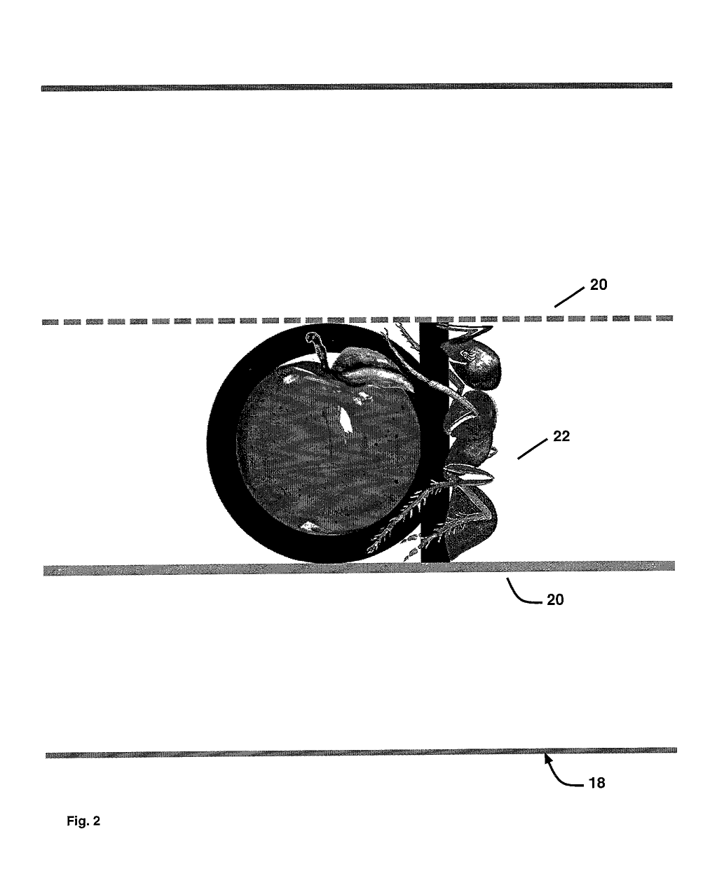

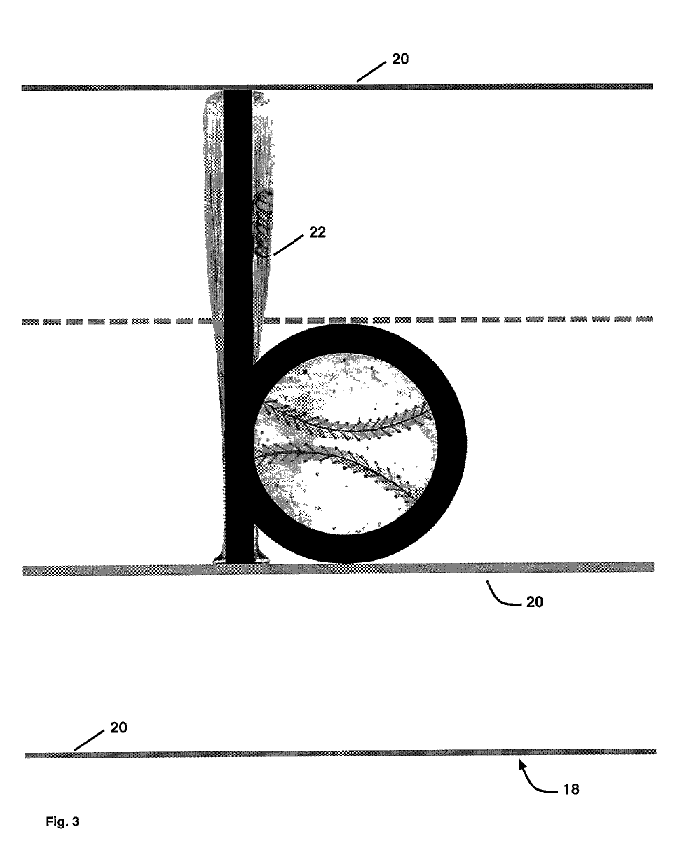

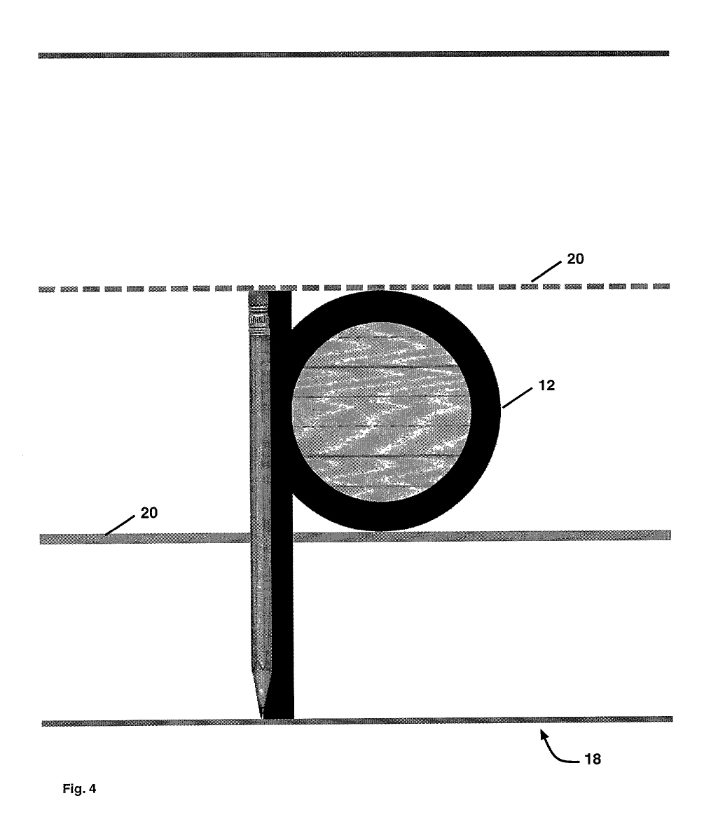

In FIGS. 2, 3, and 4, a “first impression letter card”, 18 is shown. This card builds the association between the shape of the letter, the sound the letter makes, and the formation of the strokes. In the preferred method, a plurality of such cards, one for each letter of the alphabet, each comprising an illustration 22, which integrates the strokes of the letter, with objects that take the shape of the strokes, and have the same beginning sound as the letter makes are provided. The only exception is the letter x which is represented by objects whose names have the sound of the letter x, (/ks/), at the end. A plurality of lines 20, preferably colored lines, are included on each card to help the student form and position the strokes of the letters on specially lined paper, as seen in FIG. 9, which has the same color lines and spacing as the first impression letter cards 18.

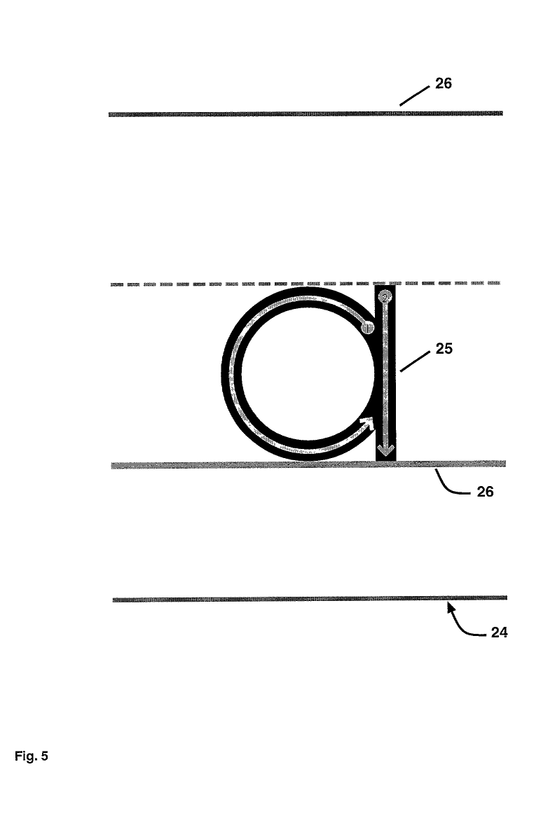

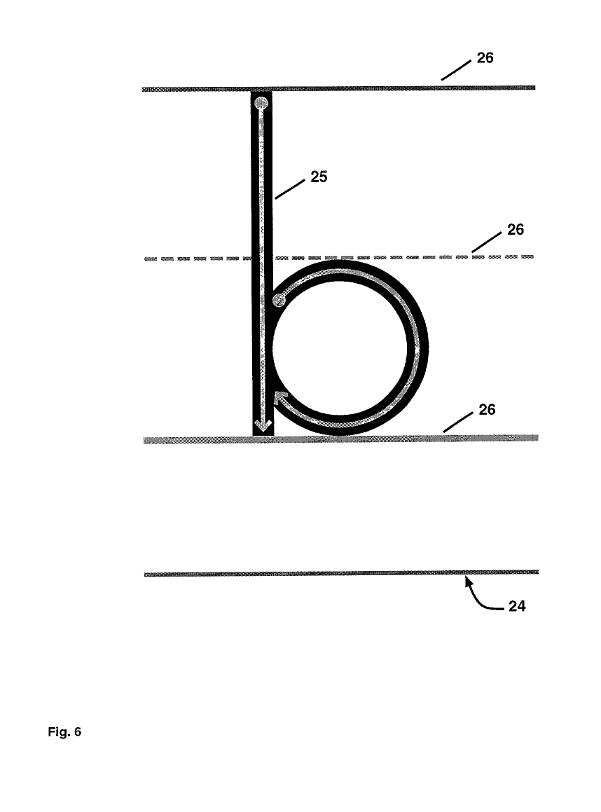

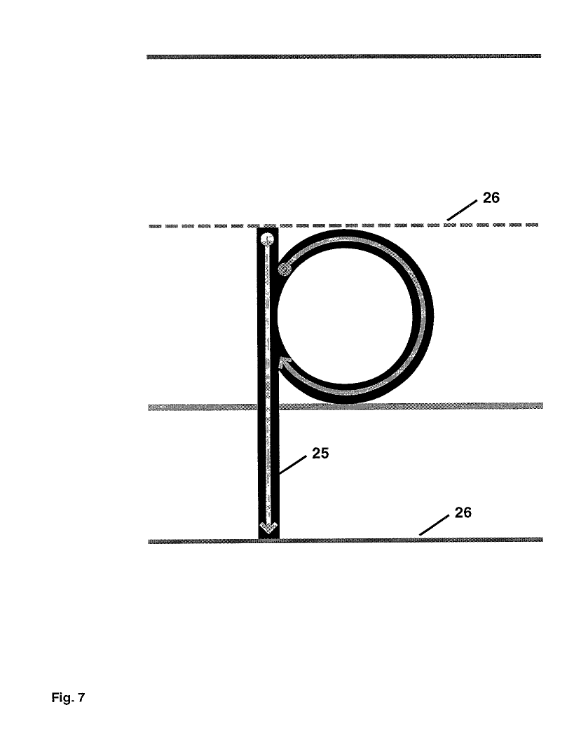

With reference now to FIGS. 5, 6, and 7, a plurality of “way to go” cards 24, are provided. In one embodiment, fifty two 5½″×8½, one for each lower case and each upper case letter 25, of the alphabet, with the order of the strokes numbered and color coded, and the direction of the strokes illustrated within the strokes of that letter. The objects that take the shape of the strokes are eliminated on this card. These cards help transfer the association between the letter shape and the letter sound made on the first impression letter cards 18, to a card with no visual clues except the shape of the letter itself. The lower case way to go cards 24, can help reinforce the sound the letter makes, if the student says the words that were initially presented with the first impression card 12, as he or she traces over the strokes of the letters. This card is a good way to test whether the student is ready to go to the next first impression letter card 18, or needs more practice. If the student can say the letter sound, when shown this card, the “letter-sound association” has taken place. If the teacher can say the sound and the student can write the letter for that sound then the “sound-letter association” has taken place. The upper case cards can be used to match with the lower case cards, so students will learn the corresponding upper and lower case letter, and in addition, associate the same sound with the upper case letters as the sound previously learned for the lower case letters. The upper case cards are also to be used to learn the order and direction of the strokes. Multiple lines 26, which are preferably colored lines, are included on each card to help the student form and position the strokes of the letters on the write on color paper seen in FIG. 9, or on traditional lined paper. Both upper and lower case cards can also be used for practicing the name of the letter.

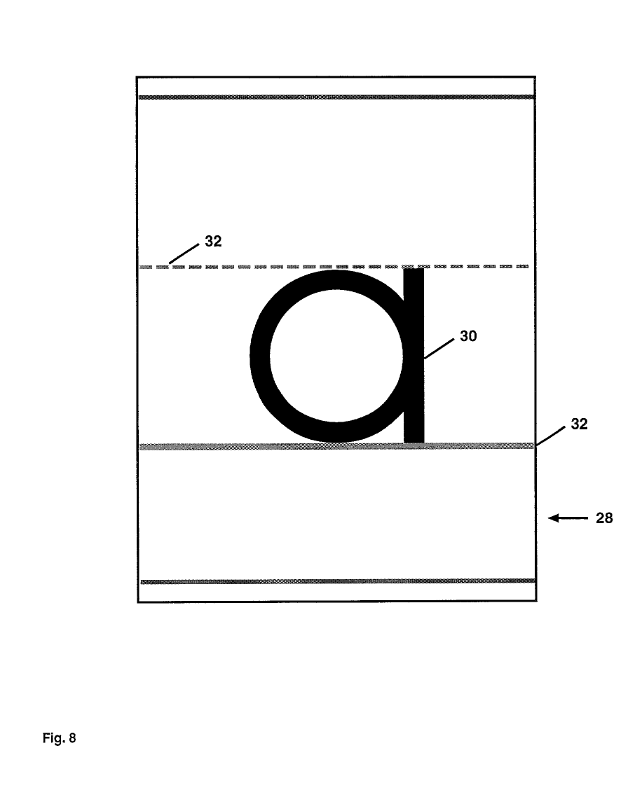

In FIG. 8, a “do you know” card 28, is shown. Preferably, there are fifty-two of such cards provided but may be other wise, which are sized 5/½×4¼″. In various embodiments, different numbers of such cards and different sizes, both larger and smaller may be provided. Do you know cards 18, preferably show one letter 30, per card, for 26 lower case letters and 26 upper case letters with lines 32, which preferably are colored and may be either solid or dashed lines as shown. These cards include the letter without any graphics or stroke directions. Cards 28 are used to test letter sound and name, and for matching lowercase letter with uppercase letter.

Referring now to FIG. 9, write on color paper 34, is shown, and is preferably spaced like primary lined paper, but with lines 36, in color, that tie first impression line cards 12, and first impression letter cards 18, to give the student a spatial reference and color clue when forming and positioning the letters 38, within and on the lines 36.

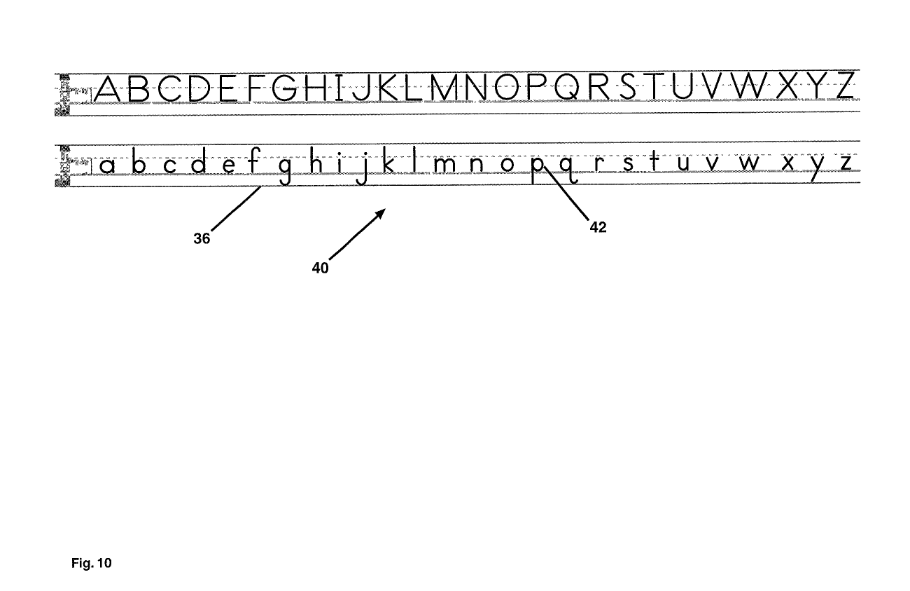

In addition to the above, a banner 40, seen in FIG. 10, an “up for show” banner composed of a heavy plastic material with lower case letters 42, may be used and designed to be mounted on a wall in a classroom for a reference for the sound of the letters of the alphabet, and the formation and placement of the uppercase and lowercase letters on primary lined paper. Preferably, the bottom row of letters display the graphics of the first impression cards 18, in alphabetical order for a reference as to the sound the letter makes. The middle letters display the graphics of the lower case way to go cards 24, in alphabetical order for a reference as to the order and directions of the strokes of the lowercase letters. Preferably, the top row of letters display the graphics of the uppercase way to go cards 24, in alphabetical order for a reference as to the order and directions of the strokes of the uppercase letters. All three rows of letters, including the color lines 36, as a reference for the positioning of the strokes of the letters of the write on color paper 34.

Each row of letters preferably begins with graphics from the first impression line cards 12, which with concrete visual imagery, represents the spacing and lines on the write on color paper 34, and gives spatial reference and color clues to help the student form and position the strokes of the letters on the write on color paper or traditional primary lined paper.

In the preferred methodology of the present invention first impression letter cards 18, in order of the alphabet, are presented to reinforce the alphabetic principle, although any order will have successful results. For example, a finger may be used to trace over the strokes of each letter on the first impression letter cards 18, while saying the name of the object that take the shape each stroke. The names of the objects are listed on the bottom of each card in the order in which the strokes are to be presented. The instructor or teacher may then end with saying the beginning sound of the objects, which is also the sound being taught for that particular letter. Students may then be instructed to model the same.

Next, reference may be made to a “way to go” chart which is preferably inserted with first impression cards 18, for the order, the beginning point, and the direction of the strokes for each letter 22.

Preferably, first impression line card 12, is then introduced to build spatial awareness of the size, shape and position of the strokes of the letters. The instructor or teacher then points out and introduces the names of, for example, Color Lines—the red roof, the blue clothesline, the green grass, and the brown ground. When giving directions as to the size, shape and position of the strokes of the letters, it is preferable to allude to the red roof, the blue clothesline, the green grass, and the brown ground as spatial reference points.

It is preferred to provide a set of general rules for instructing the direction of each stoke comprising each letter. The following illustrate a preferred set of rules for instructing, using the present methodology in the direction of strokes comprising each letter:

All vertical strokes go from top to bottom

All horizontal strokes go from left to right.

All diagonal strokes go from top to bottom, unless the strokes can be connected, as in the letters v and w in which case, the strokes go from top to bottom and then from bottom to top.

If a circular stroke is the first stroke of the letter it will be counterclockwise.

If a circular stroke is the second stroke of the letter it will be clockwise, unless the first stroke is a left to right vertical, then the second stroke is counterclockwise the only letter being formed this way being the letter e.

After the student is able to trace over the strokes of each letter in the correct order and direction on the first impression cards while saying the names of the objects, and the beginning sound aloud, the same should be practiced, for example, in the air, in a shallow box of salt, or on a table with their finger, and then on unlined paper with a writing object, or on a Magnadoodle with the supplied writing instruments.

After the student has been introduced to and practiced the first impression line cards 12, and first impression letter cards 18, with reasonable success, it is preferred to proceed to the way to go cards 24. Preferably, way to go cards 24, are introduced by pointing out that each card has numbers in balls for the order and beginning point of each stroke. Also the instructor points out the order of the strokes are color coded: 1) yellow 2) orange 3) pink and 4) lavender. Model tracing over the strokes of each letter saying the name of each object as presented on first impression cards 18, and the beginning sound of the objects is useful.

Then it is preferable to instruct students to model the same. If the student forgets the name of the objects, show the first impression letter card 18 for that letter, or give just say the names of the objects to recreate the previously presented visual imagery. If the student does not recall the correct order of the strokes or the correct beginning point, refer to the numbers for the order of the strokes, and the ball for the correct beginning point. Also point out the order of the strokes are color coded: 1) yellow 2) orange 3) pink and 4) lavender.

After the student is able to trace over the strokes of each letter in the correct order and direction on way to go cards 24, while saying the names of the objects, and the beginning sound aloud, instruct the student to write the letter on an unlined surface, after dictating the names of the objects, and the sound for that letter. For example: “Write the bat and the ball, /b/, or “Write the letter that says /b/, bat, ball.” At this time, if the student is successful at the previous task, the student may be introduced to the write on color paper 34, to practice the placement, order and direction of the strokes of the letters on lined paper.

At this point, to build spatial awareness reintroduce first impression line card 12, with reference to the placement of the strokes in reference to “the red roof,” “the blue clothesline,” “the green grass,” and “the brown ground”.

If the student is able to trace over the strokes of the letters on the way to go cards 24, in the correct order and direction, and give the name of the objects and beginning sound of the objects, the student is ready for introduction to do you know cards 28. Do you know cards 28, may be introduced by teacher saying just the sound for the letter when do you know cards 28, are shown. Then, the students are instructed to model the same. If this task is difficult for the student, instruct the student to say the object names silently in their head and only say the sound out loud.

If the student is still having difficulty show first impression cards 12, for that letter, or give just say the names of the objects to recreate the previously presented visual imagery. The letter name may be taught at this point, if the teacher feels this will not confuse the student with the letter sound. Preferably, the student is next instructed to blend the learned sounds together in short vowel words. In practice, an instructors manual or guide is provided for aiding the instructor in the disclosed methodology.

Preferably object names and sounds for letters of the alphabet are presented in an associational, sequential manner. Representative examples are given below, however, these are given only as examples and other object names may be used for teaching the sounds and letters of the alphabet using the present method.

1) apple, 2) ant, /a/
2) bat, 2) ball, /b/
3) car. 2) curve, /k/
4) dog, 2) daisy, /d/
5) embryo, 2) egg, /e/
6) feather, 2) finger, /f/
7) garden, 2) gopher, /g/
8) house, 2) hut, /h/
9) Inuk, 2) igloo, /i/
10) (jumping) Jack, 2) jug (of juice), /j/
11) kangaroo, 2) kite, 3) key, /k/
12) log, /l/
13) moose, (on the) 2) muddy, 3) mountains, /m/
14) nail, 2) needle, /n/
15) ostrich, /o/
16) pencil, 2) paper, /p/
17) queen, 2) quilt, /kw/
18) rope, 2) (red) ribbon, /r/
19) snake, /s/
20) tiger, 2) tail, /t/
21) udder, 2) umbrella, /u/
22) valentine, 2) valley, /v/
23) wiggly, 2) worn, 3) waggly 4) worm, /w/
24) ax, 2) box, /ks/
25) yo yo, 2) (yellow) yarn, /y/
26) zig, 2) zag, 3) zipper, /z/

Using the present method, various order options for letter and sound presentation may be used. For example, teach vowels first, then consonants. Teach letters/sounds in the order of difficulty of formation: similar shaped letters grouped together, similar sized letters grouped together, similar positioned letters grouped together, and. difficult to form letters presented last. Teach letters/sounds in alphabetical order so as to reinforce letter names and alphabetical order through expectation of next letter being presented. Teach letters/sounds in a developmental order that relates to speech acquisition order, that is, the order in which a child normally acquires sounds in typical speech/language development. Teach letters/sounds in groups according to their speech pattern or pronunciation similarities, being the similarity in forming the sound through use of lips, tongue, palettes. Teach letters/sounds in groups according vowels and consonants of similar shape, size, and position on lined paper. For example,

| | | |
|---|---|---|
| 1. | 1/2 space/vowels: | o, i, a, e, u |
| 2. | 1/2 space /consonants: | c, n, m, r, s, v, w, x, z |
| 3. | full space/ascenders/consonants: | l, b, d, h, f, k |
| 4. | 3/4 space/ascender/consonant: | t |
| 5. | descenders/consonants: | p, g, j, y, q, |

As is evident from the above description, a wide variety of instructional applications may be utilized which incorporate the methodology herein described and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. An instructional method for teaching the sounds of the alphabet, the formation of the strokes of the letters of the alphabet, and the placement of the letters of the alphabet on primary lined paper, comprising:
instructing the learning of a sound of a letter of the alphabet prior to any instruction on sound blending;
illustrating each letter of the alphabet by incorporating an object which conforms to a shape of a writing stroke for each letter, said object having the same beginning sound as the letter being illustrated; and,
teaching an exact positioning for each stroke which comprises a letter of the alphabet on primary spaced and lined paper.

2. The method of claim 1, wherein each letter of the alphabet letters is illustrated on cards.

3. The method of claim 2, wherein said cards include a plurality of lines.

4. The method of claim 3, wherein said plurality of lines are colored.

5. The method of claim 1, wherein a vowel sound is introduced first by way of a short vowel sound.

6. The method of claim 1, further including a second plurality of lined cards so as to give a spatial reference and color clue to aid in a correct form and positioning of said writing strokes of the letters of the alphabet.

7. The method of claim 1, further including a third plurality of cards, one for each lower case letter and one for each upper case letter of the alphabet, with the order of strokes numbered and color coded, and the direction of the strokes numbered.

8. The method of claim 1, further including a fourth plurality of cards, one for each lower case letter and one for each upper case letter, said fourth plurality of cards do not include any graphics or stroke direction indicia.

9. The method of claim 1, further including the use of a lined paper, said lines of said lined paper being colored.

10. The method of claim 1, further including a banner for mounting on the wall of a classroom.

11. An educational method for teaching the sounds of the alphabet, the formation of the strokes of the letters of the alphabet, and the placement of the letters of the alphabet on primary lined paper, comprising:
teaching the learning of a sound of a letter of the alphabet prior to any instruction on sound blending;
illustrating each letter of the alphabet by incorporating an object which conforms to a shape of a writing stroke for each letter, said object having the same beginning sound as the letter being illustrated; and,
instructing an exact positioning for each stroke which comprises a letter of the alphabet on primary spaced and color-lined paper.

12. The method of claim 11, wherein each letter of the alphabet letters is illustrated on cards.

13. The method of claim 11, wherein said cards include a plurality of colored lines.

14. The method of claim 11, wherein a vowel sound is introduced first by way of a short vowel sound.

15. The method of claim 11, further including a second plurality of lined cards so as to give a spatial reference and color clue to aid in a correct form and positioning of said writing strokes of the letters of the alphabet.

16. The method of claim 11, further including a third plurality of cards, one for each lower case letter and one for each upper case letter of the alphabet, with the order of strokes numbered and color coded, and the direction of the strokes numbered.

17. The method of claim 11, further including a fourth plurality of cards, one of each of said fourth plurality of cards representing each lower case letter and one of each of said fourth plurality of cards representing each upper case letter.
